(19) United States
(12) Patent Application Publication
(10) Pub. No.: US 2016/0150315 A1
(43) Pub. Date: May 26, 2016

(54) SYSTEM AND METHOD FOR ECHO CANCELLATION

(71) Applicant: GM GLOBAL TECHNOLOGY OPERATIONS LLC, Detroit, MI (US)

(72) Inventors: ELI TZIRKEL-HANCOCK, RA'ANANA (IL); MD FOEZUR RAHMAN CHOWDHURY, TROY, MI (US); BASSAM S. SHAHMURAD, CLINTON TOWNSHIP, MI (US); ILAN MALKA, TEL AVIV (IL)

(21) Appl. No.: 14/549,099

(22) Filed: Nov. 20, 2014

(51) Int. Cl. H04R 3/00

(52) U.S. Cl. CPC H04R 3/002; H04R 2499/13; H04R 2499/11

(57) ABSTRACT

Systems and methods are provided for improving acoustic echo cancellation in a cabin of a vehicle. A source of far end speech is detected using a far end speech control module. A main beam directed at a speaking occupant and based on the far end speech is formed using a beam forming module. An echo cancelation filter is formed based on the far end speech using an acoustic echo cancellation module. An audible communication from the speaking occupant is received with at least one microphone in a microphone array to generate a microphone signal. The microphone signal is filtered using a spatial filter based on the main beam and the echo cancellation filter to generate a cabin output signal which is broadcasted to the source of far end speech.

### TECHNICAL FIELD

The technical field generally relates to echo cancellation, and more particularly relates to systems and methods for echo cancellation for multiple microphones.

### BACKGROUND

Modern vehicles, such as automobiles, are often equipped with systems to facilitate communication between occupants of the vehicle and a person on a far end device, such as a cellular phone. For instance, a hands free calling system may use one or more microphones in the vehicle cabin to transmit audible communications from the vehicle occupants to a remote caller while broadcasting far end speech from the remote caller over the vehicle's audio system. However, the broadcasted far end speech may be received by the microphones and consequently result in unwanted feedback and acoustic echo in the signal transmitted to the remote caller. As such, the remote caller may hear an acoustic echo in the signal received from the hands free calling system.

Accordingly, it is desirable to provide systems and methods for echo cancellation in a cabin that allows echo cancellation of far end speech for multiple microphones with a minimized number of acoustic echo cancellation modules (AECMs). In addition, it is desirable to enhance communications between occupants in the cabin and a far end device. Other desirable features and characteristics of the present invention will become apparent from the subsequent detailed description and the appended claims, taken in conjunction with the accompanying drawings and the foregoing technical field and background.

### SUMMARY

In one embodiment, a method is provided for facilitating acoustic echo cancellation in a cabin of a vehicle. In accordance with the method a source of far end speech is detected using a far end speech control module. A main beam directed at a speaking occupant based on the far end speech is formed using a beam forming module. An echo cancelation filter is formed based on the far end speech using an acoustic echo cancellation module. An audible communication from the speaking occupant is received with at least one microphone in a microphone array to generate a microphone signal. The microphone signal is filtered using a spatial filter based on the main beam and the echo cancellation filter based on the far end speech to generate a cabin output signal which is broadcasted to the source of far end speech.

In one embodiment, a system is provided for facilitating acoustic echo cancellation in a cabin of a vehicle. The system includes a far end speech control module having a processor and a memory. The far end speech control module detects a source of far end speech and broadcasts a cabin output signal to the source of far end speech. A microphone array receives an audible communication from a speaking occupant and generates a microphone signal based on the audible communication. A beam forming module forms a main beam directed at the speaking occupant based on the far end speech. An acoustic echo cancellation module forms an echo cancellation filter based on the far end speech. A spatial filter based on the main beam and the echo cancellation filter is applied to the microphone signal to generate the cabin output signal, which is then broadcast to the source of far end speech.

### DESCRIPTION OF THE DRAWINGS

The exemplary embodiments will hereinafter be described in conjunction with the following drawing figures, wherein like numerals denote like elements, and wherein:

FIG. 1 illustrates a vehicle having the acoustic echo cancellation system in accordance with an exemplary embodiment;

FIG. 2 illustrates the acoustic echo cancellation system in accordance with an exemplary embodiment;

FIG. 3 is a flow chart illustrating a method for acoustic echo cancellation with the system shown in FIG. 1;

FIG. 4 illustrates the acoustic echo cancellation system in accordance with an exemplary embodiment;

FIG. 5 illustrates the acoustic echo cancellation system in accordance with an exemplary embodiment;

FIG. 6 illustrates the acoustic echo cancellation system in accordance with an exemplary embodiment;

FIG. 7 illustrates the acoustic echo cancellation system in accordance with an exemplary embodiment; and

FIG. 8 illustrates the acoustic echo cancellation system in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

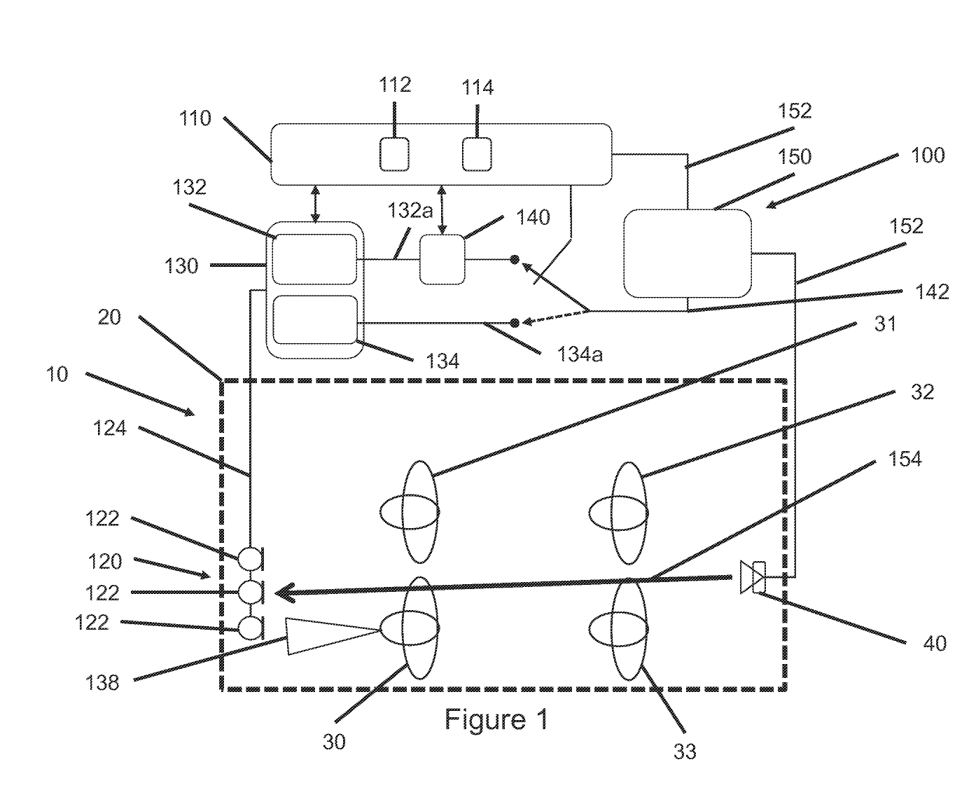

Referring to the Figures, wherein like numerals indicate like parts throughout the several views, a vehicle 10 having a cabin 20 and an acoustic echo cancellation system 100 is shown herein. In the exemplary embodiments, the vehicle 10 is an automobile. However, the acoustic echo cancellation system 100 may be implemented and/or utilized in other types of vehicles or in non-vehicle applications. For instance, other vehicles include, but are not limited to, aircraft, spacecraft, buses, trains, etc. As shown in FIG. 1, the acoustic echo cancellation system 100 includes a far end speech control module 110 having a processor module 112 and a memory 114, a microphone array 120, a beam forming module 130, an acoustic echo cancellation module 140, and a source of far end speech 150.

With reference to FIG. 1, an embodiment of the acoustic echo cancellation system 100 is provided. The vehicle 10 includes the microphone array 120 to pick up audible commands and communications from occupants 30-33 in the cabin 20. In one example, the microphone array 120 is used to receive audible commands and communications from a speaking occupant 30. In one example, the microphone array 120 receives audible commands to enable the speaking occupant 30 to communicate via speech recognition with one or more vehicle systems, such as infotainment systems, etc. over a vehicle communication bus.

The vehicle 10 uses the microphone array 120 and a loudspeaker 40 to enable vehicle occupants 30-33 to communicate with a source of far end speech 150, such as a remote mobile phone that is distant from the vehicle 10. The source of far end speech 150 is broadcasted over the loudspeaker 40 so that the vehicle occupants 30-33 can hear the communications from the source of far end speech 150. However, the audible far end speech 154 can be picked up by the microphone array 120 and subsequently rebroadcasted to the source of far end speech 150 as an echo. As such, acoustic echo cancellation is necessary to improve communications between the source of far end speech 150 and the vehicle occupants 30-33 in the cabin 20.

The acoustic echo cancellation system 100 includes the far end speech control module 110, the microphone array 120, the beam forming module 130, the acoustic echo cancellation module 140, and the source of far end speech 150. While the components of the acoustic echo cancellation system 100 are depicted in communication through a direct connection for simplicity, one skilled in the art will appreciate that the acoustic echo cancellation system 100 may be implemented over a vehicle communication bus such as a CAN bus, FlexRay, A2B bus or other known communication busses.

The far end speech control module 110 transmits and receives data within the acoustic echo cancellation system 100 and has the processor module 112 and the memory 114. The processor module 112 performs computing operations and accesses electronic data stored in the memory 114. The memory 114 may include a predetermined location of a speaking occupant 30-33, predetermined acoustic zones in the cabin 20, or other predetermined spatial relationships relating to the vehicle cabin 20.

The far end speech control module 110 detects a far end speech signal 152 originating from the source of far end speech 150 which is in turn broadcast in the cabin 20 using the loudspeaker 40 as the audible far end speech 154. By receiving the far end speech signal 152 as an input, the acoustic echo cancellation system 100 is able to acoustically remove the far end speech signal 152 from the cabin output signal 142 provided to the source of far end speech 150, thus removing the echo. The far end speech control module 110 further selects between the fixed beam former output signal 132a and the adaptive beam former output signal 134a based on the presence of the far end speech signal 152.

The microphone array 120 includes at least two microphones 122 and receives audible communications from a speaking occupant (not shown) and generates a microphone signal 124 therefrom. In an embodiment of the acoustic echo cancellation system 100, the microphones 122 in the microphone array 120 are arranged proximate to one another in the cabin. One skilled in the art will appreciate that the microphones 122 in the microphone array 120 form a phased sensor array and therefore should be located reasonably close to one another. In an embodiment, the microphones 122 are arranged to form zones in the cabin 20 with one microphone 122 per zone. In an embodiment, there are at least two microphones 122 per zone. In an embodiment, the microphones 122 are arranged in the cabin 20 so that there is one dedicated microphone 122 per occupant 30-33. In an embodiment, there are at least two microphones 122 per occupant 30-33.

The beam forming module 130 forms a main beam 138 directed at the speaking occupant 30. The beam forming module 130 of the embodiment in FIG. 1 includes a fixed beam former 132 and an adaptive beam former 134. Based on the detection of the far end speech signal 152 by the far end speech control module 110, the beam forming module 130 forms a main beam 138 with either the fixed beam former 132 or the adaptive beam former 134. When the fixed beam former 132 is used, the direction of the main beam 138 is fixed. When the adaptive beam former 134 is used, the beam orientation may vary dynamically depending on occupant position, interference and acoustic conditions in the cabin.

Adaptive beam forming or spatial filtering is a technique that uses sensor arrays to provide directional signal reception. By making use of a phased array, signals at particular angles experience constructive interference while signals at other angles experience destructive interference. In this way, beam forming provides a method for constructing a spatial filter to selectively increase the amplitude of signals received at some angles while simultaneously reducing the amplitude of signals received at other angles.

The location of the speaking occupant 30 implicitly identified in the beam forming adaptation of the adaptive beam former 134. The location of the speaking occupant 30 may also be a predetermined location stored in the memory 114 as detailed above.

The location of the speaking occupant 30 may also be identified by the beam former 130 by minimizing the variance of the adaptive beam former output signal 134a as is known to those skilled in the art. The beam former 130 may further make use of algorithms such as the Linear Constrained Minimum Variance (LCMV) algorithm to implicitly estimate the location of the speaking occupant 30. In an embodiment, the location of the speaking occupant 30 is predetermined. In an embodiment, a vehicle sensor (not shown) such as a seat sensor provides information relating to the location of the occupants 30-33 relative to the microphone array 120. For example, a seat sensor may be used to determine if a front seat passenger 31 is in the cabin 20. The sensor may also provide information relating to the location of the driver 30 on the seat.

Adaptive beam forming is achieved by filtering and processing the microphone signal 124 from the microphone array 120 and combining the beam forming outputs. The beam forming module 130 can be used to extract the desired signal and reject interfering signals according to their spatial location. In this way, the beam forming module 130 processes signals received by the microphone array 120 to extract desired communications such as the speaking occupant's 30 voice while rejecting unwanted signals such ambient noise in the cabin 20.

In an embodiment, the adaptive beam former 134 is used when no far end speech is detected by the far end speech control module 110. One skilled in the art will appreciate that when no far end speech is being broadcast within the cabin 20, it is not necessary to perform acoustic echo cancellation on the microphone signal 124. In this instance, the microphone signal 124 is filtered using a spatial filter based on the main beam to generate the adaptive beam former output signal 134a which is selected by the far end speech control module 110 to be the cabin output signal 142 which is then broadcast to the source of far end speech 150.

When the far end speech control module 110 detects incoming communications from the source of far end speech 150 which will in turn be broadcast in the cabin 20 as the audible far end speech 154, acoustic echo cancellation is performed on the microphone signal 124 before broadcasting the cabin output signal 142 to the source of far end speech 150.

Acoustic echo cancellation is performed by the far end speech control module 110 detecting the presence of far end speech signal 152 originating from the source of far end speech 150. The far end speech signal 152 is broadcasted over the loudspeaker 40 as the audible far end speech 154 and may be subsequently picked up by the microphone array 120. As such, the far end speech signal 152 may be present, with delay, in the microphone signal 124. The acoustic echo cancellation module 140 removes the echo, when necessary, by subtracting the far end speech signal 152 from the fixed beam former output signal 134a to generate the cabin output signal 142.

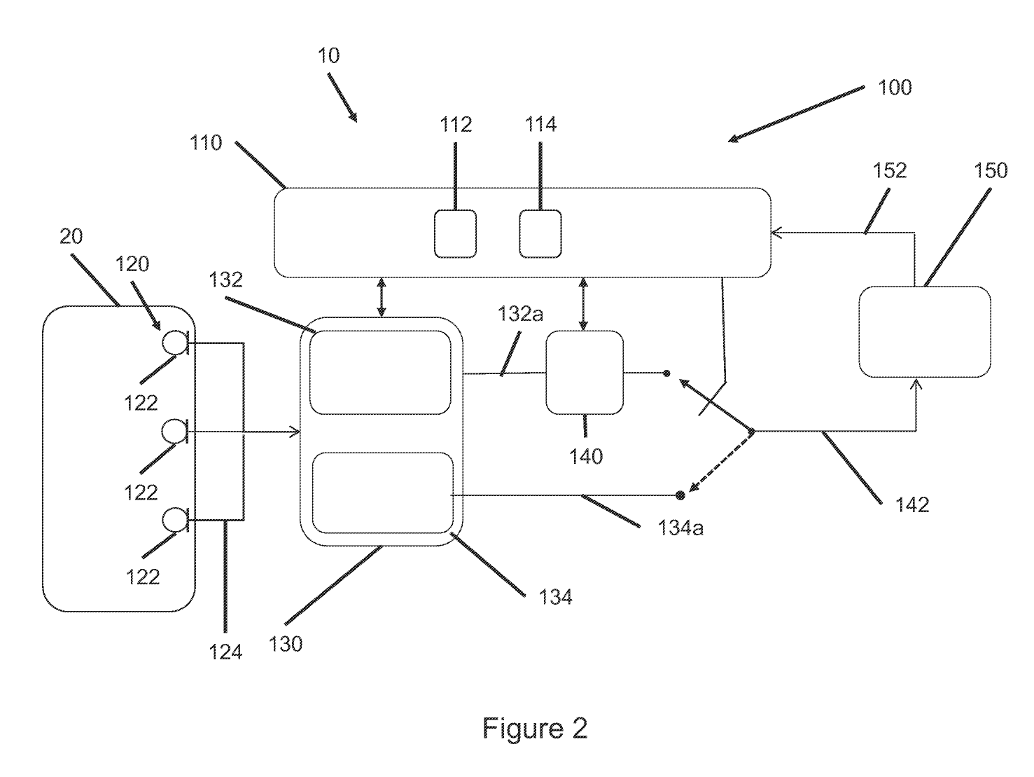

As such, in the embodiment of the acoustic echo cancellation system 100 of FIGS. 1 and 2, when the far end speech control module 110 detects incoming communications from the source of far end speech 150, the beam forming module 130 forms a main beam 138 with the fixed beam former 132 after which a single acoustic echo cancellation module 140 is used to perform echo cancellation on the fixed beam former output signal 132a to generate the cabin output signal 142. In this way, the beam forming module 130 selectively uses either the fixed beam former output signal 132a or the adaptive beam former output signal 134a based on the presence of far end speech signal 152 detected by the far end speech control module 110.

When using the adaptive beam former 134, the beam forming module 130 in conjunction with the microphone array 120 implicitly identifies the location of the speaking occupant 30 as detailed above. As known to those skilled in the art, the beam forming module 130 may simultaneously form the main beam 138 and filter the microphone output signal 124.

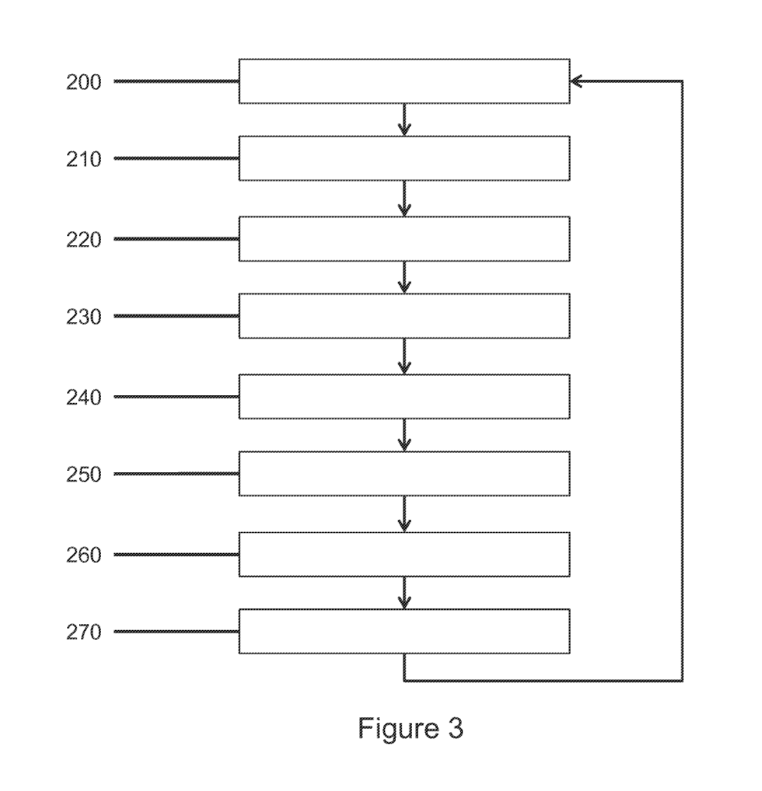

Referring now to FIG. 3, and with continued reference to FIG. 2, a flowchart illustrates a method performed by the acoustic echo cancellation system 100 of FIGS. 1 and 2 in accordance with the present disclosure. As can be appreciated in light of the disclosure, the order of operation within the method is not limited to the sequential execution as illustrated in FIG. 3, but may be performed in one or more varying orders as applicable and in accordance with the requirements of a given application. As discussed above, the beam forming module 130 may simultaneously form the main beam 138 and filter the microphone output signal 124.

In various exemplary embodiments, the acoustic echo cancellation system 100 and method are run based on predetermined events, and/or can run continuously during operation of the vehicle 10. The method starts at 200. At 210, the far end speech signal 152 is detected by the far end speech control module 110. At 220, the main beam 138 is formed by the beam former module 130 and directed at the location of the speaking occupant 30. Additionally, as detailed above, at 220 the main beam 138 may be formed by the fixed beam former 132 or the adaptive beam former 134. At 230, the echo cancellation filter is formed by the acoustic echo cancellation module 140 based on the far end speech signal 152 detected by the far end speech control module 110.

At 240, an audible communication from the speaking occupant 30 is received by the microphones 122 of the microphone array 120 to generate a microphone signal 124. At 250, the microphone signal 124 is filtered and processed using a spatial filter as a function of the main beam 138 and the echo cancellation filter to generate the cabin output signal 142. At 260, the cabin output signal 142 is broadcasted to the source of the far end speech. At 270, the method ends.

One skilled in the art will appreciate that at 250 additional filtering and processing may occur to improve the quality of the cabin output signal 142. For example, noise reduction and dynamic amplification based on noise in the cabin 20 may also be performed.

In this way, the acoustic echo cancellation system 100 uses the far end speech control module 110, the microphone array 120, the beam forming module 130, and the acoustic echo cancellation module 140 to spatially filter signals that are subsequently broadcast to the source of far end speech 150. The beam forming module 130 uses the fixed beam former 132 to form the main beam 138 when the far end speech control module 110 detects the far end speech signal 152 and the adaptive beam former 134 when there is not far end speech.

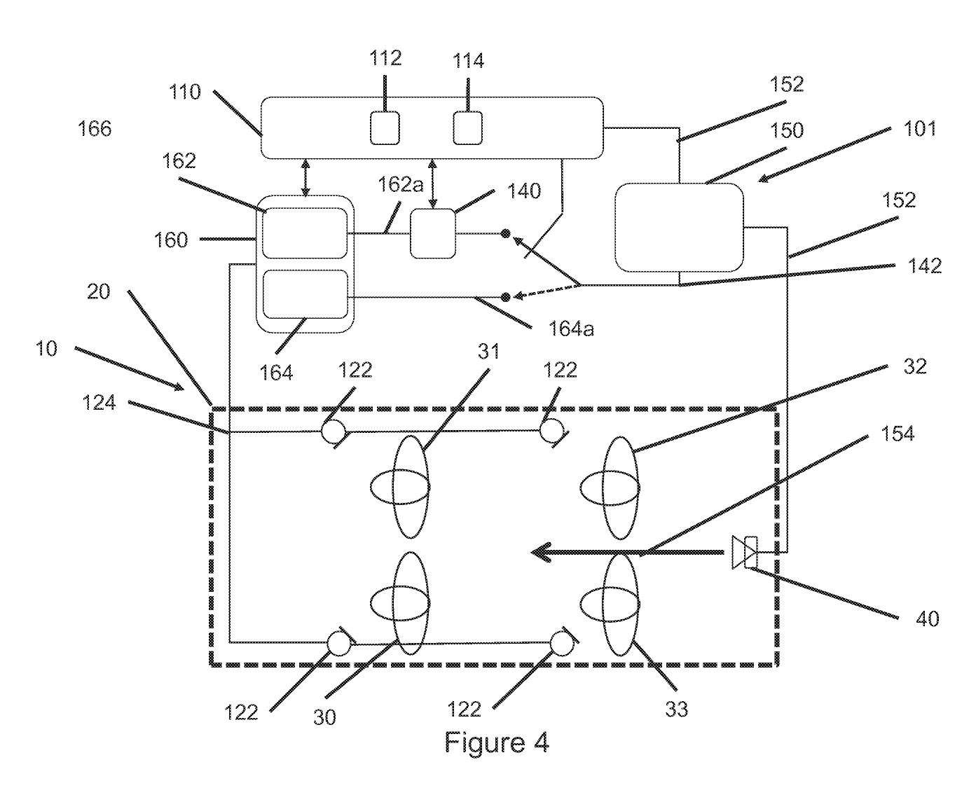

With reference now to FIG. 4, an embodiment of the acoustic echo cancellation system 101 is provided. In this embodiment, the acoustic echo cancellation system 101 makes use of a microphone processing module 160 having a fixed microphone mixer 162 and an adaptive microphone selection module 164. As similar components are used in the acoustic echo cancellation system 101 relative to the acoustic echo cancellation system 100, similar reference numerals will be used. As with the embodiment from FIG. 2, the acoustic echo cancellation system 101 includes the far end speech control module 110, the microphone array 120, the acoustic echo cancellation module 140, and the source of far end speech 150.

The fixed microphone mixer 162 mixes the microphone signal 124 from each microphone 122 according to a predetermined mixing setting. The predetermined mixing setting may be stored in the memory 114 and may include changing the microphone signal 124 level or other dynamics. The adaptive microphone selection module 164 selects the microphone 122 based on the speaking occupant 30. For example, each microphone 122 may be tuned to a specific occupant 30-33. As such, when an occupant 30-33 is speaking, the adaptive microphone selection module 164 selects the microphone 122 tuned to the corresponding occupant 30-33.

Similar to the embodiment of FIG. 2, the use of the fixed microphone mixer 162 and the adaptive microphone selection module 164 in the generation of the cabin output signal 142 depends on whether the far end speech control module 110 detects the far end speech signal 152. When the far end speech control module 110 detects the far end speech signal 152, the microphone processing module 160 uses the fixed microphone mixer 162 to generate the fixed microphone mixer output signal 162a, after which a single acoustic echo cancellation module 140 is used to perform echo cancellation and generate the cabin output signal 142 as detailed above.

In contrast, when the far end speech signal 152 is not detected by the far end speech control module 110, the microphone processing module 160 uses the adaptive microphone selection module 164 to generate the adaptive microphone selection output signal 164a. In this way, the microphone processing module 160 selectively uses either the fixed microphone mixer 162 to generate the fixed microphone mixer output signal 162a or the adaptive microphone selection module 164 to generate the adaptive microphone selection output signal 164a based on the presence of the far end speech signal 152 detected by the far end speech control module 110.

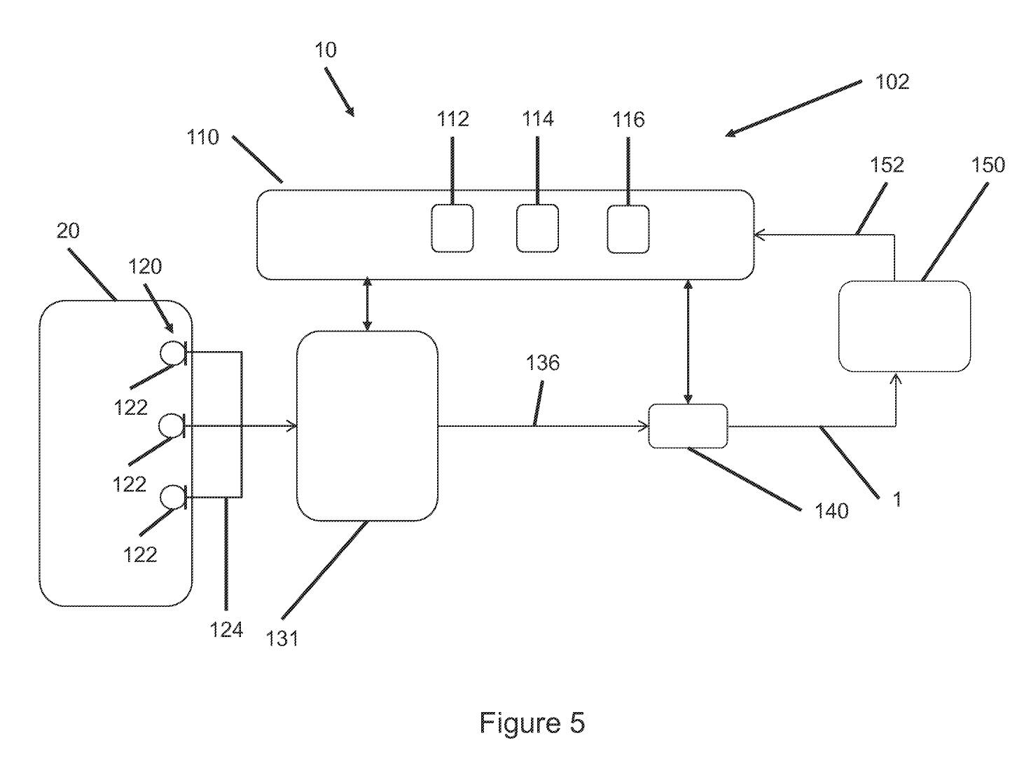

With reference now to FIG. 5, an embodiment of the acoustic echo cancellation system 102 is provided. In this embodiment, the acoustic echo cancellation system 102 makes use of a variable adaptive rate beam forming module 131. As similar components are used in the acoustic echo cancellation system 102 relative to the acoustic echo cancellation systems 100, 101, similar reference numerals will be used. As with the previously described embodiments, the acoustic echo cancellation system 102 includes the far end speech control module 110, the microphone array 120, the acoustic echo cancellation module 140, and the source of far end speech 150.

In the embodiment in FIG. 5, the far end speech control module 110 includes an adaptive rate control module 116. The adaptive rate control module 116 variably adjusts the adaptive rate of the variable adaptive rate beam forming module 131 based on the presence of the far end speech signal 152. When the far end speech control module 110 detects far end speech, the adaptive rate control module 116 slows the adaptive rate of the variable adaptive rate beam forming module 131. In the present embodiment, when the far end speech signal 152 is detected and it becomes necessary to perform acoustic echo cancellation, the adaptive rate control module 116 slows, or in some cases stops, the adaptive rate of the variable adaptive rate beam forming module 131. Stated differently, when the far end speech signal 152 is not detected, the variable adaptive rate beam forming module 131 effectively functions as an adaptive beam former. However, when the far end speech signal 152 is detected and the adaptive rate is slowed, or in some cases stopped, the beam forming module 131 effectively functions as a fixed beam former.

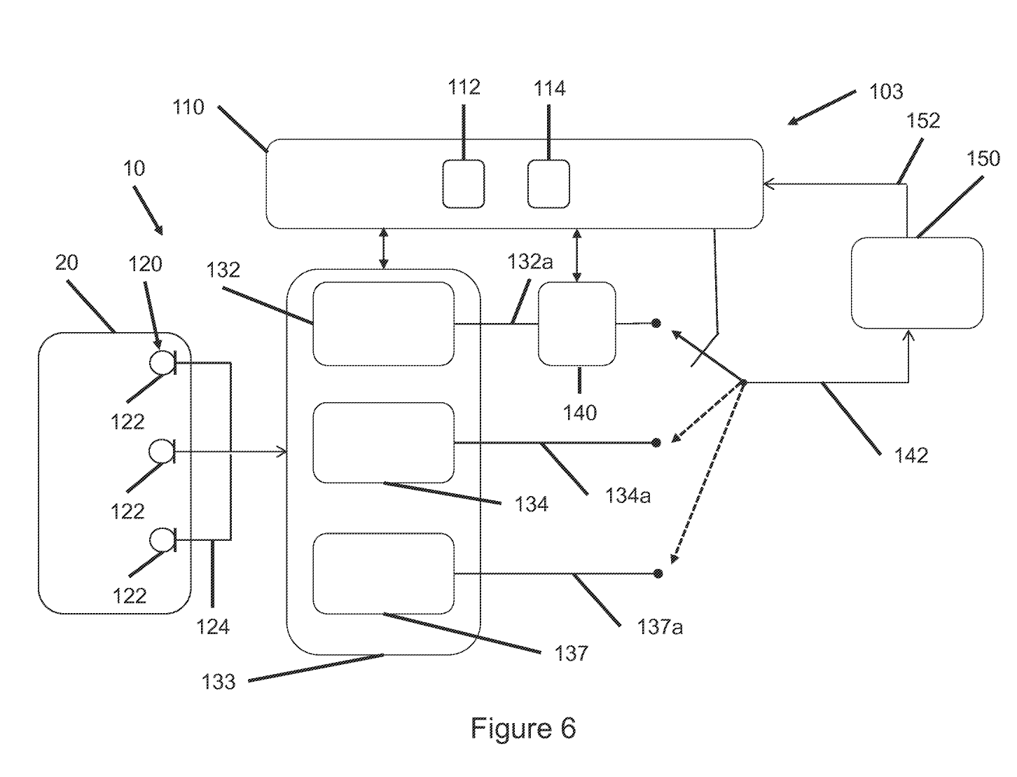

With reference now to FIG. 6, an embodiment of the acoustic echo cancellation system 103 is provided. In this embodiment, the acoustic echo cancellation system 103 makes use of a beam forming module 133 having a fixed beam former 132 and multiple adaptive beam formers 134, 137. As similar components are used in the acoustic echo cancellation system 103 relative to the acoustic echo cancellation systems 100-102, similar reference numerals will be used. As with the previously described embodiments, the acoustic echo cancellation system 103 includes the far end speech control module 110, the microphone array 120, the acoustic echo cancellation module 140, and the source of far end speech 150.

The embodiment of FIG. 6 is an extension of the embodiment in FIG. 2 that allows for zoning in the cabin 20 for when multiple occupants 30-33 are speaking One skilled in the art will appreciate that while there are two adaptive beam formers 134, 137 depicted in the beam forming module 133, additional adaptive beam formers 134, 137 may be utilized to allow for creation of additional zones within the cabin 20 without departing from the spirit of the disclosure. It is therefore understood that the number of adaptive beam formers 134, 137 shown in FIG. 6 is merely exemplary, and that additional adaptive beam formers 134, 137 are contemplated by the present disclosure.

In the embodiment in FIG. 6, the adaptive beam formers 134, 137 are used by the beam forming module 133 when no far end speech signal 152 is detected by the far end speech control module 110 and are selected based on the active zone. For example, adaptive beam former 134 may correspond to a first zone of the cabin 20 and adaptive beam former 137 may correspond to a second zone of the cabin 20. If the first zone is the active zone, adaptive beam former output signal 134a is selected. If the second zone is the active zone, adaptive beam former output signal 137a is selected. As such, multiple acoustic zones may be formed in the cabin 20, as is known to those skilled in the art.

Similarly, when the far end speech control module 110 detects the far end speech signal 152, the beam forming module 133 selectively uses the fixed beam former 132 to generate the fixed beam former output signal 132a as detailed above relative to FIG. 2. Accordingly, the present embodiment allows for acoustic echo cancellation to be performed with multiple zones provided for multiple speaking occupants.

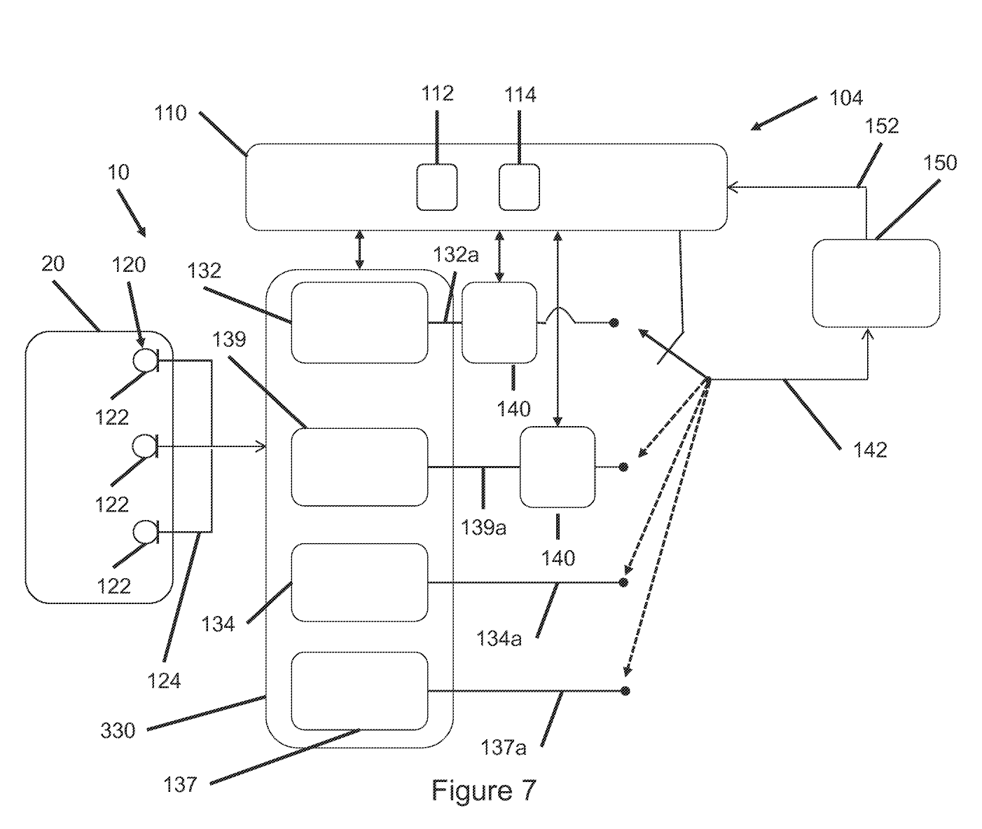

With reference now to FIG. 7, an embodiment of the acoustic echo cancellation system 104 is provided. In this embodiment, the acoustic echo cancellation system 104 includes a beam forming module 330 having a fixed beam former 132, 139 and an adaptive beam former 134, 137 per zone in the cabin 20. As similar components are used in the acoustic echo cancellation system 104 relative to the acoustic echo cancellation systems 100-103, similar reference numerals will be used. As with the previously described embodiments, the acoustic echo cancellation system 104 includes the far end speech control module 110, the microphone array 120, acoustic echo cancellation modules 140, and the source of far end speech 150.

The acoustic echo cancellation system 104 is an extension of the acoustic echo cancellation system 103 of FIG. 6 that allows for zoning and echo cancellation in the cabin 20 for when multiple occupants 30-33 are speaking and there is far end speech. One skilled in the art will appreciate that while there are two adaptive beam formers 134, 137 and two fixed beam formers 132, 139 depicted in the beam forming module 330, additional adaptive beam formers 134, 137 and fixed beam formers 132, 139 may be utilized to allow for creation of additional zones within the cabin 20 without departing from the spirit of the disclosure. It is therefore understood that the number of adaptive beam formers 134, 137 and fixed beam formers 132, 139 shown in FIG. 7 is merely exemplary, and that additional adaptive beam formers 134, 137 and fixed beam formers 132, 139 are contemplated by the present disclosure. Furthermore, there may be multiple adaptive beam formers 134, 137 for each zone in the cabin 20 such that there are more total adaptive beam formers 134, 137 than fixed beam formers 132, 139.

In the acoustic echo cancellation system 104, there is one fixed beam former 132, 139, one acoustic echo cancellation module 140, and one adaptive beam former 134, 137 for each zone in the cabin 20. For example, if there are two zones in the cabin 20, the fixed beam former 132 and adaptive beam former 134 would be provided to process the first zone and the fixed beam former 139 and the adaptive beam former 137 would be provided to process the second zone. However, as detailed above, additional adaptive beam formers 134, 137 for each zone are contemplated by the present disclosure.

In the embodiment in FIG. 7, the adaptive beam formers 134, 137 are used by the beam forming module 330 when no far end speech signal 152 is detected by the far end speech control module 110 and are selected based on the active zone. For example, adaptive beam former 134 may correspond to the first zone of the cabin 20 and adaptive beam former 137 may correspond to the second zone of the cabin 20. If the first zone is the active zone, adaptive beam former output signal 134a is selected. If the second zone is the active zone, adaptive beam former output signal 137a is selected. As such, multiple acoustic zones may be formed in the cabin 20, as is known to those skilled in the art.

Similarly, when the far end speech control module 110 detects the far end speech signal 152, the beam forming module 330 the fixed beam formers 132, 139 are selectively used based on the active zone. For example, fixed beam former 132 may correspond to the first zone of the cabin 20 and fixed beam former 139 may correspond to the second zone of the cabin 20. If the first zone is the active zone, fixed beam former output signal 132a is selected. If the second zone is the active zone, fixed beam former output signal 139a is selected. This configuration also allows for acoustic echo cancellation to be performed on both zones simultaneously. For example, if both zone one and zone two are active and there is far end speech, acoustic echo cancellation may be performed on both zones. Accordingly, the present embodiment allows for acoustic echo cancellation to be performed with multiple zones provided for multiple speaking occupants.

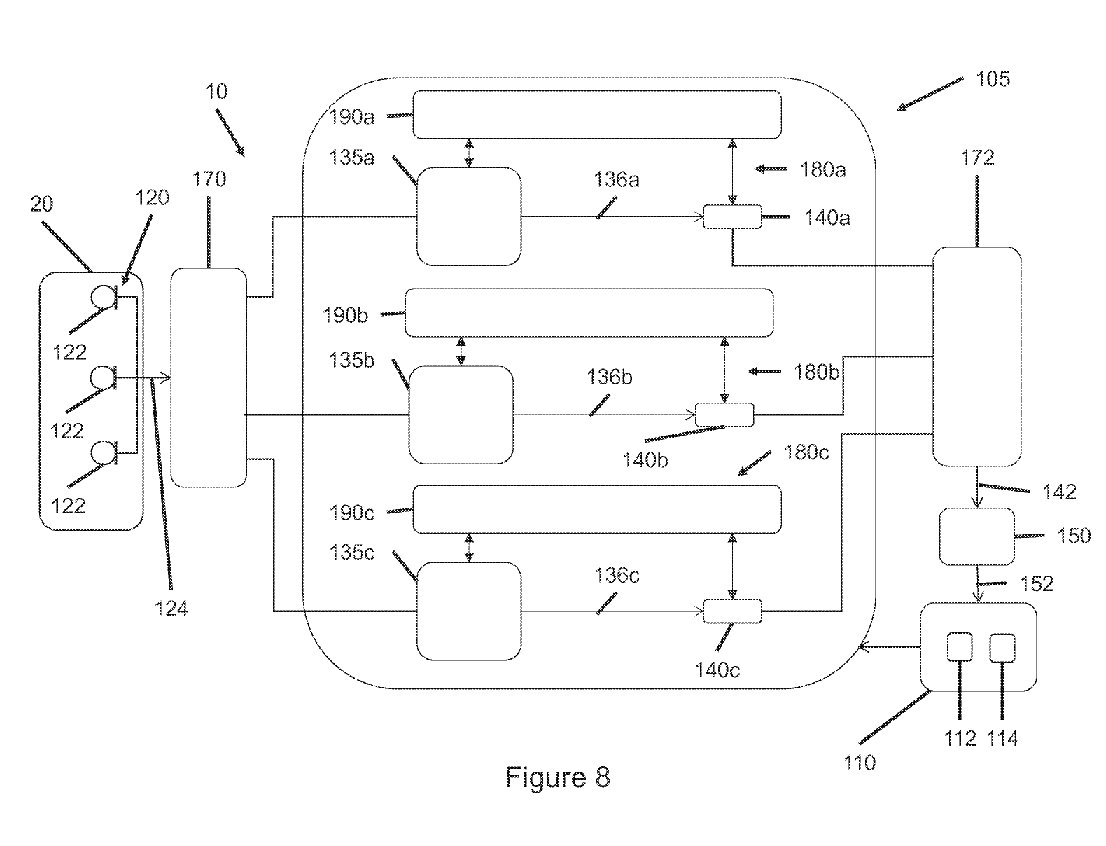

With reference now to FIG. 8, an embodiment of the acoustic echo cancellation system 105 is provided. In this embodiment, the acoustic echo cancellation system 105 splits the microphone signal 124 generated by the microphone array 120 into a plurality of frequency bands with an analysis filter bank 170. Each of the frequency bands has a sub-band signal which is independently processed to remove acoustic echoes. Additionally, far end speech detection, beam forming, and other processing is performed on each band. After acoustic echo cancellation is performed on each of the sub-band signals, the sub-band signals are synthesized by a synthesis filter bank 172 to generate the cabin output signal 142 which is in turn broadcasted to the source of far end speech 150. As similar components are used in the acoustic echo cancellation system 105 relative to the acoustic echo cancellation systems 100-104, similar reference numerals will be used.

As seen in FIG. 8 and similar to the previously described embodiments, the acoustic echo cancellation system 104 includes the far end speech control module 110, the microphone array 120, and the source of far end speech 150. However, in this embodiment the acoustic echo cancellation system 104 includes a plurality of the sub-band processing modules 180a-c. Each of the sub-band processing modules 180a-c includes a beam forming module 135a-c, the acoustic echo cancellation module 140a-c, and a configuration and adaption controller module 190a-c. In this way, each of the sub-band processing modules 180a-c independently processes one of the sub-band signals generated by the analysis filter bank 170.

One skilled in the art will appreciate that while there are three sub-band processing modules 180a-c depicted in FIG. 8, additional sub-band processing modules 180a-c may be utilized to allow for creation of additional frequency sub-bands within the cabin 20 without departing from the spirit of the disclosure. It is therefore understood that the number of sub-band processing modules 180a-c shown in FIG. 8 is merely exemplary and that additional sub-band processing modules 180a-c are contemplated by the present disclosure.

Each of the sub-band processing modules 180a-c receives a sub-band signal from the analysis filter bank 170. Based on the far end speech signal 152 detected by the far end speech control module 110, the adaption controller modules 190a-c control the acoustic echo cancellation modules 140a-c to filter the beam forming output signals 136a-c. The signals outputted by each of the sub-band processing modules 180a-c are then synthesized by the synthesis filter bank 172 to generate the cabin output signal 142 which is in turn broadcast to the far end device 150.

In all of the previously described embodiments, the beam forming module can be replaced with a microphone mixer. For example, a fixed beam former may be replaced with a fixed microphone mixer and an adaptive beam former may be replaced with an adaptive microphone mixer. In this way, it is contemplated that components such as microphone mixers can be substituted for beam forming modules without departing from the spirit of the invention.

While various exemplary embodiments have been presented in the foregoing detailed description, it should be appreciated that a vast number of variations exist. It should also be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

What is claimed is:

1. A method of facilitating acoustic echo cancellation in an area, comprising:
detecting a source of far end speech using a far end speech control module;
forming a main beam for a speaking occupant based on the far end speech using a beam forming module;
forming an echo cancelation filter based on the far end speech using an acoustic echo cancellation module;
receiving an audible communication from the speaking occupant with at least one microphone in a microphone array and generating a microphone signal based on the audible communication;
filtering the microphone signal using a spatial filter based on the main beam, the echo cancellation filter, and the far end speech to generate an output signal; and
broadcasting the output signal to the source of far end speech.

2. The method of claim 1, further comprising:
selecting between at least one fixed beam former output signal and at least one adaptive beam former output signal based on the far end speech.

3. The method of claim 1, further comprising:
selecting between at least one fixed microphone mixer output signal and at least one adaptive microphone mixer output signal based on the far end speech.

4. The method of claim 1, further comprising:
adaptively forming the main beam at an adaption rate with the beam forming module, the adaption rate based on the far end speech.

5. The method of claim 1, further comprising:
adaptively forming a plurality of main beams with a plurality of beam forming modules, each main beam directed at a zone in the area based on the far end speech; and
filtering the microphone signal by selecting the main beam of the plurality of main beams based on the speaking occupant.

6. The method of claim 1, further comprising:
splitting the microphone signal into a plurality of frequency bands, each frequency band having a sub-band signal;
filtering each of the sub-band signals with a sub-band beam forming module using a spatial filter based on the frequency band and the echo cancellation filter to generate a sub-band beam signal; and
synthesizing the sub-band signals to generate the output signal.

7. A system for acoustic echo cancellation in a cabin, comprising:
a far end speech control module having a processor and a memory, the far end speech control module configured to detect a source of far end speech and broadcast a cabin output signal to the source of far end speech;
a microphone array configured to receive an audible communication from a speaking occupant and generate a microphone signal in response there to;
a beam forming module configured to form a main beam for the speaking occupant based on the far end speech;
an acoustic echo cancellation module configured to form an echo cancellation filter based on the far end speech; and
a spatial filter configured to filter the microphone signal based on the main beam and the echo cancellation filter, and to generate the cabin output signal based on the microphone signal.

8. The system of claim 7, further comprising:
at least one fixed beam forming module configured to generate at least one fixed beam forming output signal; and
at least one adaptive beam forming module configured to generate at least one adaptive beam forming output signal,
wherein the at least one fixed beam forming output signal and the at least one adaptive beam forming output signal are selected based on the far end speech.

9. The system of claim 7, further comprising:
at least fixed microphone mixer module configured to generate at least one fixed microphone mixer output signal; and
at least one adaptive microphone mixer module configured to generate at least one adaptive microphone mixer output signal,
wherein the at least one fixed microphone mixer output signal and the at least one adaptive microphone mixer output signal are selected based on the far end speech.

10. The system of claim 7, wherein the beam forming module is configured to adaptively form the main beam at an adaption rate based on the far end speech.

11. The system of claim 10, wherein the adaption rate is reduced when far end speech is detected.

12. The system of claim 7, further comprising:
at least two beam forming modules configured to form at least two main beams,
wherein each main beam is directed at a zone in the cabin and the spatial filter is based on the main beam from at least one selected zone.

13. The system of claim 7, further comprising:
a sub-band filter configured to split the microphone signal into a plurality of sub-bands based on a band frequency; and
a synthesis filter configured to join the plurality of sub-bands to generate the acoustic signal,
wherein the spatial filter is configured to filter each of the sub-bands based on the band frequency.

14. A vehicle, comprising:
a cabin; and
a system for acoustic echo cancellation in the cabin, the system including:
a far end speech control module having a processor and a memory, the far end speech control module configured to detect a source of far end speech and broadcast a cabin output signal to the source of far end speech;
a microphone array for receiving an audible communication from a speaking occupant and generating a microphone signal in response there to;
a beam forming module configured to form a main beam for the speaking occupant based on the far end speech;
an acoustic echo cancellation module configured to form an echo cancellation filter based on the far end speech; and
a spatial filter configured to filter the microphone signal based on the main beam and the echo cancellation filter, and to generate the cabin output signal based on the microphone signal.

15. The system of claim 14, further comprising:
at least one fixed beam forming module configured to generate at least one fixed beam forming output signal; and
at least one adaptive beam forming module configured to generate at least one adaptive beam forming output signal,
wherein the at least one fixed beam forming output signal and the at least one adaptive beam forming output signal are selected based on the far end speech.

16. The vehicle of claim 14, further comprising:
at least fixed microphone mixer module configured to generate at least one fixed microphone mixer output signal; and
at least one adaptive microphone mixer module configured to generate at least one adaptive microphone mixer output signal,
wherein the at least one fixed microphone mixer output signal and the at least one adaptive microphone mixer output signal are selected based on the far end speech.

17. The vehicle of claim 14, wherein the beam forming module is configured to adaptively form the main beam at an adaption rate based on the far end speech.

18. The vehicle of claim 17, wherein the adaption rate is reduced when far end speech is detected.

19. The vehicle of claim 14, further comprising:
at least two beam forming modules configured to form at least two main beams,
wherein each main beam is directed at a zone in the cabin and the spatial filter is based on the main beam from at least one selected zone.

20. The vehicle of claim 14, further comprising:
a sub-band filter configured to split the microphone signal into a plurality of sub-bands based on a band frequency; and
a synthesis filter configured to join the plurality of sub-bands to generate the cabin output signal,
wherein the spatial filter is configured to filter each of the sub-bands based on the band frequency.
